(19) United States
(12) Patent Application Publication
(10) Pub. No.: US 2025/0153525 A1
(43) Pub. Date: May 15, 2025

(54) SHOCK ABSORBER, TELESCOPIC SUSPENSION FORK AND MACPHERSON STRUT SUSPENSION

(71) Applicant: Klaus WOHLFARTH, Fichtenberg (DE)

(72) Inventors: Klaus WOHLFARTH, Fichtenberg (DE); Jürgen KÄLBERER, Schwäbisch Gmünd (DE)

(21) Appl. No.: 18/834,287

(22) PCT Filed: Jan. 27, 2023
(86) PCT No.: PCT/EP2023/051990

§ 371 Date: Jul. 30, 2024

(30) Foreign Application Priority Data
Jan. 31, 2022 (DE) 10 2022 200 994.0

(51) Int. Cl. B60G 15/06

(52) U.S. Cl. CPC B60G 15/068; B60G 2202/24; B60G 2202/312; B60G 2204/128; B60G 2204/416; B60G 2300/12; B60G 2500/112; B60G 2500/40

(57) ABSTRACT

A shock absorber for a wheel suspension of a vehicle, wherein the shock absorber is configured to absorb wheel steering forces. The shock absorber has an outer tube with a plunger piston movable in the outer tube in and against a longitudinal direction of the outer tube for damping a movement when changing a length of the shock absorber in a first direction, and a piston provided with a radial seal for damping a movement when changing the length of the shock absorber in a second direction opposite the first direction.

The invention relates to a shock absorber for a wheel suspension of a vehicle, wherein the shock absorber is designed to absorb wheel steering forces. The invention also relates to a telescopic suspension fork and to a MacPherson strut suspension.

The intention of the invention is to improve a shock absorber, a telescopic suspension fork and a MacPherson strut suspension.

Provided according to the invention is a shock absorber for a wheel suspension of a vehicle, wherein the shock absorber is designed to absorb wheel steering forces; having an outer tube, having a plunger piston, which is displaceable in the outer tube in and counter to a longitudinal direction of the outer tube, for displacing damper fluid and thus for damping a movement when altering the length of the shock absorber in a first direction, and having a piston, which is provided with a radial seal, for displacing damper fluid and thus for damping a movement when altering the length of the shock absorber in a second direction which is counter to the first direction.

The combination of a plunger piston and a piston with a radial seal has surprising advantages in terms of transmitting wheel steering forces, in terms of the responsiveness of the shock absorber, in terms of an installation space required for the shock absorber, and also in terms of an adjustability of the damping behavior in a compression phase and a traction phase. Damping the movement when altering the length of the shock absorber is performed by means of damper valves by way of which the damper fluid that is displaced by the plunger piston or the piston provided with a radial seal flows. The plunger piston plunges into the outer tube and is guided radially in the outer tube. The bearing points of the plunger piston on the inside of the outer tube can simultaneously be lubricated by means of the damper fluid. The combination of a plunger piston and a piston with a radial seal is advantageous in terms of a required installation space because no coaxial tubes are required to generate annular gaps for directing the damper fluid within the shock absorber. A very positive responsiveness of the shock absorber according to the invention can be achieved by low bearing friction because the mounting of the plunger piston on the inside of the outer tube is at all times lubricated with the damper fluid, usually damper oil. The shock absorber according to the invention therefore is highly sensitive in terms of its response, and in particular does not exhibit any stick-slip effects in which the damper thus initially does not respond and only responds abruptly once a breakaway torque of the seal has been overcome. Due to the plunger piston being combined with a piston with a radial seal, two bearing points within the outer tube can be disposed very far apart. As a result, the shock absorber already has a very stiff design due to its construction, owing to the fact that an ideally large bearing spacing is set, and as a result can transmit wheel steering forces almost without play and without any elastic deformation. The plunger piston can be of a very stable embodiment. The shock absorber according to the invention can be designed in such a way that a bearing spacing between the two bearings that support the plunger piston on the inside of the outer tube is enlarged during compression. When the wheel steering forces increase during compression, the bearing spacing of the two bearings for mounting the plunger piston on the inside of the outer tube is enlarged in such a way that very favorable lever ratios prevail. A plunger piston herein is a piston which in portions rests directly on the inside of the outer tube and which by means of a seal at the entrance of the outer tube, in other words thus in the region of the open end of the outer tube, wherein the plunger piston is inserted into the open end, is sealed in relation to the inner wall of the outer tube. The plunger piston plunges into the piston chamber formed by the outer tube and by way of its volume disposed in the piston chamber displaces fluid in the piston chamber. In contrast, the piston with a radial seal displaces fluid by way of its piston stroke; the displacement of the piston with a radial seal is thus independent of the volume of the piston. The combination of a plunger piston and a piston with a radial seal in the shock absorber according to the invention also enables a very good accessibility and thus adjustability of the damper valves which can be disposed outside the outer tube, or can at least be readily rendered to be accessible from outside the outer tube.

In a refinement of the invention, the plunger piston is designed to be hollow at least in portions, and a fastening device for fastening the shock absorber to a vehicle structure or to the wheel suspension is at least in portions disposed within the plunger piston.

As a result, a spacing between the fastening device for fastening the shock absorber and the first and the second bearing for mounting the plunger piston on the inside of the outer tube can be kept very small in comparison to conventional shock absorbers. As a result, wheel steering forces that are introduced into the shock absorber by way of the wheel suspension, and then into a vehicle structure by way of the fastening device, can be transmitted onward without the shock absorber being deformed in such a way that the driving characteristics of a vehicle are negatively affected. In other words, a lever between the fastening device for fastening the shock absorber to a vehicle structure or to the wheel suspension, in particular of a ball joint, and the radial mounting of the plunger piston in the outer tube of the shock absorber is kept as short as possible.

In a refinement of the invention, the fastening device has a ball joint.

The ball joint is advantageously disposed completely within the plunger piston.

In a refinement of the invention it is provided that the plunger piston is designed to be hollow at least in portions; that the plunger piston at a first bearing point in the region of an open end of the outer tube is mounted radially on the internal circumference of the outer tube; and that the plunger piston at a second bearing point is mounted radially on the internal circumference of the outer tube, wherein a wall thickness of the plunger piston in a region which comes into contact with the first bearing point when altering the length of the shock absorber is smaller than a wall thickness of the plunger piston in a region which comes into contact with the second bearing point when altering the length of the shock absorber.

A consistent lightweight construction is possible in the shock absorber according to the invention because a large wall thickness is provided only where large bending forces arise when introducing wheel steering forces.

In a refinement of the invention, the plunger piston is designed to be hollow at least in portions, and the piston provided with a radial seal is disposed so as to be displaceable within the cavity of the plunger piston.

In this way, large damper travels can be achieved without the shock absorber becoming excessively long. Such a concept can be used in rally vehicles, for example.

In a refinement of the invention, the piston provided with a radial seal is connected to the plunger piston by way of a piston rod.

A so-called through-rod concept is implemented in this way, because the plunger piston, or the piston rod formed by an extension of the plunger piston, extends through a radial seal on the outer tube and can also move in and counter to the longitudinal direction relative to this radial seal.

In a refinement of the invention, the plunger piston displaces damper fluid in the direction toward a fluid duct which lies outside the outer tube, wherein the fluid duct is provided with a damper valve.

In other words, a piston chamber which is invaded by the plunger piston, in particular during compression of the shock absorber, is fluidically connected to a fluid duct which is disposed outside the outer tube and in which a damper valve is disposed. In this way, an adjustment of the damping can take place on the damper valve and thus outside the outer tube. As a result, the damper valve can be rendered to be very well accessible in such a way that it is possible to rapidly and readily set the damping effect.

In a refinement of the invention, the piston provided with a radial seal displaces damper fluid in the direction toward a fluid duct which is disposed outside the outer tube, wherein the fluid duct is provided with a damper valve.

In other words, a piston chamber which is decreased in size by the piston provided with a radial seal, in particular during decompression of the shock absorber, is fluidically connected to a fluid duct which is disposed outside the outer tube and in which a damper valve is disposed. Fluid is thus displaced in the direction toward fluid ducts that lie outside the outer tube in the compression phase as well as in the traction phase. The damper valves can in this instance be disposed in these fluid ducts so that an adjustment of the damping effect from the outside is readily possible.

The object on which the invention is based is also achieved by a telescopic suspension fork for a two-wheeler, having at least one shock absorber according to the invention.

The precise transmission, or introduction, of wheel steering forces into a vehicle structure, in most instances a frame of the two-wheeler, is eminently important in telescopic suspension forks for two-wheelers. This also applies to telescopic suspension forks for bicycles or electric bikes. The plunger piston of the shock absorber according to the invention is in this instance typically responsible for the traction phase of the shock absorber.

The object on which the invention is based is also achieved by a MacPherson strut suspension for a motor vehicle, having at least one shock absorber according to the invention.

The shock absorber according to the invention can ensure a precise and reliable transmission of wheel steering forces specifically in very fast or dynamic motor vehicles, in particular racing and rally vehicles, without the shock absorber per se being excessively deformed in the process. In a MacPherson strut suspension, the plunger piston is typically responsible for the compression phase of the shock absorber.

Further features and advantages of the invention are derived from the claims and the description hereunder of preferred embodiments of the invention in conjunction with the drawings. Individual features of the different exemplary embodiments illustrated and/or described can be combined with one another in an arbitrary manner without departing from the scope of the invention. This also applies to the combination of individual features without further individual features with which they are conjointly illustrated and/or described. In the drawings:

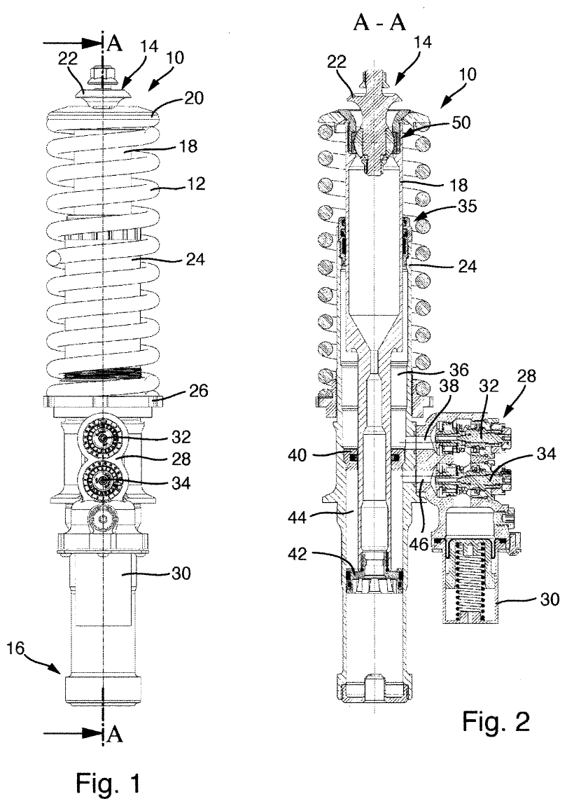

FIG. 1 shows a shock absorber according to the invention according to a first embodiment, in a lateral view;

FIG. 2 shows a view onto the section plane A-A in FIG. 1;

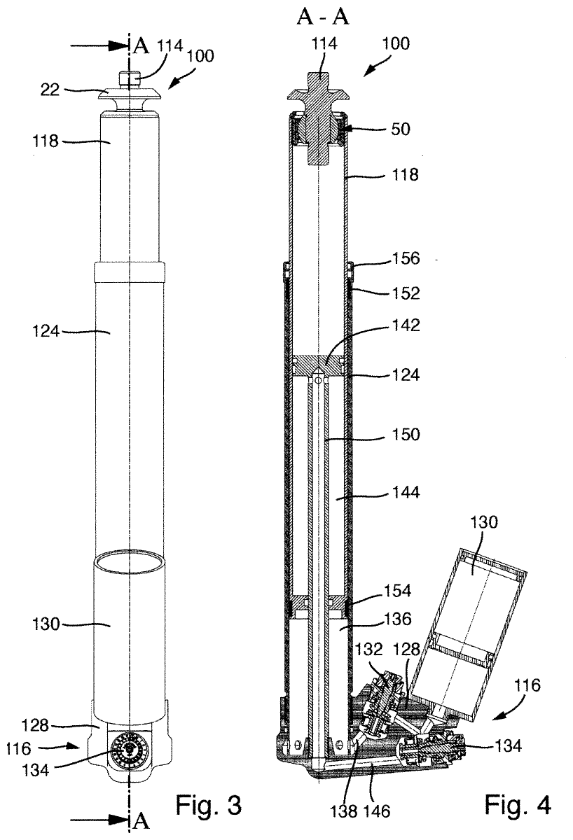

FIG. 3 shows a lateral view of a shock absorber according to the invention and according to a second embodiment;

FIG. 4 shows a view onto the section plane A-A in FIG. 3;

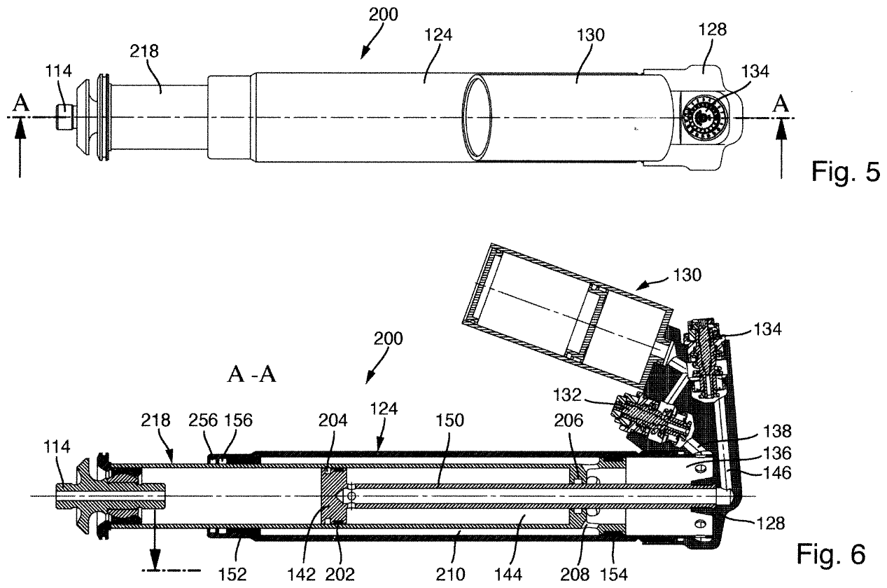

FIG. 5 shows a sectional view of a shock absorber according to the invention and according to a third embodiment; and

FIG. 6 shows a view onto the section plane A-A in FIG. 5.

FIG. 1 shows a shock absorber 10 according to the invention, which is designed for transmitting wheel steering forces and which is combined with a chassis suspension spring 12. An upper end 14 of the shock absorber 10 in FIG. 1 is provided for fastening to a vehicle structure. A lower end 16 of the shock absorber 10 in FIG. 1 is provided for connecting to a wheel support. The shock absorber 10 and the chassis suspension spring 12 thus form parts of a so-called MacPherson strut suspension for a motor vehicle.

The shock absorber 10 has a plunger piston 18, a spring seat 20 being fastened to the upper end of the latter, and a pivot pin 22 for fastening to the vehicle structure being inserted into the upper end thereof, see also FIG. 2.

As can be derived from FIG. 2, the pivot pin 22 forms part of a ball joint which is disposed within the plunger piston 18.

The shock absorber 10 moreover has an outer tube 24 which likewise supports a spring seat 26. The chassis suspension spring 12 is received between the two spring seats 20, 26. The lower spring seat 26 in FIG. 1 can be adjusted on an external thread of the outer tube 24 so as to increase or decrease a preload of the chassis suspension spring 12 and in order to ultimately be able to set a chassis suspension height of the chassis suspension.

Connected to the outer tube 24 is a valve block 28 which in turn is connected to a compensation vessel 30. An adjustable compression phase valve 32 and a likewise adjustable traction phase valve 34 are provided in the valve block 28. The compression phase valve 32 and the traction phase valve 34 are damper valves. It can be readily seen in the view of FIG. 1 that the compression phase valve 32 as well as the traction phase valve 34 are very well accessible from the outside of the shock absorber 10.

The length of the shock absorber 10 is shortened when the wheel suspension not illustrated in FIG. 1 is compressed, and the plunger piston 18, proceeding from the position in FIG. 1, thus plunges deeper into the outer tube 24. The length of the shock absorber 10 is enlarged when the wheel suspension is decompressed, and the plunger piston 18, proceeding from the position in FIG. 1, moves further out of the outer tube 24.

In the scope of the invention, the shock absorber 10 can also be disposed in such a way that the upper end 14 in FIG. 1 is provided for fastening to a wheel suspension, and the end 16 illustrated at the bottom in FIG. 1 is provided for fastening to a vehicle structure.

FIG. 2 shows a view onto the section plane A-A in FIG. 1. The plunger piston 18 in the embodiment illustrated is designed to be hollow across its entire length, wherein the wall thickness of the plunger piston varies when viewed across its length.

The plunger piston 18 is sealed by means of a radial seal and a radial bearing 35 at the upper end of the outer tube 24. The radial seal and the radial bearing 35 are provided on the inside of the outer tube 24 in such a way that the plunger piston 18 can move relative to the radial seal and relative to the radial bearing 35. It can be seen that the plunger piston 18 has the largest external diameter in its portion that is guided on the radial bearing 35. However, this largest external diameter is still smaller than the internal diameter of the outer tube 24. A piston chamber 36, into which the plunger piston 18 is moved somewhat during compression and from which said plunger piston 18 is again moved out somewhat during decompression while the shock absorber 10 alters its length, lies between the first radial bearing 35 and a second radial bearing 40 through which the plunger piston 18 is guided. Consequently, damper fluid is displaced from the piston chamber 36 in that a comparatively large volume of the plunger piston 18 plunges into the piston chamber 36 and as a result displaces damper fluid located in the piston chamber 36. Damper fluid from the piston chamber 36 is displaced into a first fluid duct 38 in the valve block 28 by means of the plunger piston 18. The first fluid duct leads to the compression phase valve 32 which is adjustable, as has been explained.

The plunger piston is embodied with a smaller diameter in the region of the second radial bearing 40, thus forming a piston rod, wherein a piston 42 which is provided with a radial seal and consequently is sealed in relation to the inside of the outer tube 24 is disposed on the lower end of the plunger piston 18, or of the piston rod, in FIG. 2. The piston 42, which is provided with a radial seal, delimits a second piston chamber 44 which is disposed between the second radial bearing 40 and the piston 42 provided with a radial seal. The wall thickness of the plunger piston is at the minimum at the connection between the plunger piston 18, or the piston rod, and the piston 42.

When the plunger piston 18 moves downward relative to the outer tube 24 in FIG. 2, thus when the vehicle suspension is compressed, the piston 42, which is provided with a radial seal, moves away from the second radial bearing 40 in such a way that the second piston chamber 44 is enlarged, and damper fluid flows into the second piston chamber 44.

In contrast, the length of the shock absorber 10 increases in length when the vehicle suspension is decompressed, and consequently the plunger piston 18 moves toward the top in FIG. 2 and somewhat out of the outer tube 24. Damper fluid in the second piston chamber 44 is thus displaced by means of the piston 42 provided with a radial seal, and flows into a second fluid duct 46 in the valve block 28. The fluid makes its way via the second fluid duct 46 to the traction phase valve 34 which is adjustable, as has been explained, and then via the valve block 28 into the first piston chamber 36.

The compensation vessel 30 is provided to compensate any thermal expansion of the damper fluid in the two piston chambers 36, 44. Because the shock absorber 10 is designed as a through-rod construction, the damper fluid flows from the first piston chamber 36 into the valve block 28 and then into the second piston chamber 44, and vice versa. The compensation chamber 30 is not required for this purpose and can therefore be of a small embodiment because only a volumetric change of the damper fluid due to thermal causes has to be compensated.

The plunger piston 18 has a very large diameter in the region of the first radial bearing 35, said diameter being smaller than the internal diameter of the outer tube 24 only by the thickness of the first radial bearing 35. Owing to the large diameter of the plunger piston 18 in the region of the first radial bearing 35, the plunger piston 18 is therefore very stable in this region and well suited for introducing into the outer tube 24 bending forces that act on the shock absorber transversely to its central longitudinal axis, and vice versa.

The plunger piston 18 then reduces its diameter and runs in the form of a piston rod with a constant external diameter up to the piston 42 which is provided with a radial seal. The plunger piston 18 has the maximum wall thickness in the region of the reduction of the diameter from the external diameter of the plunger piston 18 to the external diameter of the piston rod. This is because high bending forces are to be expected in the region of this reduced diameter. The plunger piston then reduces its wall thickness again in stages in the profile of the piston rod up to the piston 42 which is provided with a radial seal. Weight can be saved as a result.

It can be seen by means of FIG. 2 that a spacing between the first radial bearing 35 and the piston 42 provided with a radial seal is enlarged during compression, and consequently when the length of the shock absorber 10 is shortened. Higher wheel steering forces arise during compression than during decompression. Therefore, a larger bearing spacing is available during compression, so as to direct transverse forces acting on the shock absorber 10 from the plunger piston 18 into the outer tube 24, and vice versa.

It can also be seen in FIG. 2 that the pivot pin 22 on its end which is disposed within the plunger piston 18 is provided with a ball joint 50, wherein the ball joint 50 is disposed completely within the plunger piston 18. A spacing in the longitudinal direction between the upper end 14 of the shock absorber 10, which is fastened to a vehicle structure or in the scope of the invention can also be disposed on a wheel suspension, and the first radial bearing 35 can be shortened as a result. As a result, a lever arm between the upper end 14 and the first radial bearing 35 can be kept small, so that smaller bending momentums than in conventional shock absorbers are directed into the shock absorber 10.

The shock absorber 10 is constructed according to the so-called through-rod principle. The plunger piston 18 reduces its external diameter and thus transitions integrally into the piston rod, the latter extending through the central radial seal 40 up to the piston 42 provided with a radial seal. As a result, damper fluid from the first piston chamber 36 can be directed via the valve block 28 into the second piston chamber 44, and vice versa. Consequently, the compensation chamber 30 in this through-rod principle has only to compensate a volumetric change of the damper fluid due to thermal causes, as has already been explained.

The illustration of FIG. 3 shows a shock absorber 100 according to a second embodiment of the invention in a lateral view. The shock absorber 100 has an upper end 114 which can be connected to a vehicle structure or a wheel suspension. The upper end 114 is formed by means of a pivot pin 22 which extends somewhat into a plunger piston 118, as can also be derived from the sectional view onto the section plane A-A in FIG. 4. As in the shock absorber 10 of FIGS. 1 and 2, the pivot pin 22 on its lower end, which is disposed within the plunger piston 18, is provided with a ball joint 50, the function of the latter already having been explained by means of FIGS. 1 and 2. The plunger piston 118 is hollow and has a constant external diameter and a constant wall thickness across its entire length.

The plunger piston 118 extends into an outer tube 124. On the lower end 116 of the shock absorber 100, the outer tube 124 is received in a valve block 128 to which a compensation vessel 130 is also fastened.

The shock absorber 100 is not provided with spring seats and a chassis suspension spring in the embodiment illustrated, but this may readily be provided in the scope of the invention.

To be seen on the valve block 128 is a traction phase valve 134 which is adjustable. To be seen in the sectional view of FIG. 4 is a compression phase valve 132 which is likewise adjustable and in the view of FIG. 3 is obscured by the compensation vessel 130. The traction phase valve 134 and the compression phase valve 132 form damper valves.

When the shock absorber 100, proceeding from the position in FIG. 4, is reduced in its length between the first end 114 and the second end 116, the plunger piston 118 is moved somewhat further into the outer tube 124. As a result, damper fluid from a first piston chamber 136 is displaced in the direction toward a first fluid duct 138 in the valve block 128, and makes its way to the compression phase valve 132.

When a length of the shock absorber 100, proceeding from the position in FIG. 4, is enlarged between the first end 114 and the second end 116, the plunger piston 118 is moved somewhat out of the outer tube 124. A piston 142, having a radial seal not illustrated, is guided within the hollow plunger piston 118. The piston 142 is disposed so as to be immovable relative to the outer tube 124, because said piston 142 is connected to the valve block 128, and thus to the lower end of the outer tube 124, by means of a hollow piston rod 150. The piston rod 150 in the embodiment illustrated is fastened to the valve block 128. When the plunger piston 118 is thus extracted somewhat from the outer tube 124, damper fluid from a second piston chamber 144 is displaced into the piston rod 150 and in the direction toward a second fluid duct 146 in the valve block 128. The damper fluid then flows via the traction phase valve 134.

It can be seen by means of the sectional view of FIG. 4 that the plunger piston is guided on the upper end of the outer tube 124 by means of a first radial bearing 152, and is then supported on its lower end by means of a second radial bearing 154 likewise on the inside of the outer tube 124. The first radial bearing 152 is fastened to the inside of the outer tube 124, and the second radial bearing 154 is fastened to the outside of the plunger piston 118. On the one hand, the spacing between the first radial bearing 152 and the second radial bearing 154 is very large; on the other hand, this bearing spacing is enlarged during compression of the shock absorber 100. In this way, a very large lever arm is available so as to also reliably absorb large bending momentums transverse to the central longitudinal axis of the shock absorber 100. The second radial bearing 154 is not sealed in relation to the piston chamber 136. In this way, damper fluid can move between the outer wall of the plunger piston 118 and the inner wall of the outer tube 124 and make its way up to a radial bearing 156 at the upper end of the outer tube 124. The two radial bearings 152, 154 are thus at all times lubricated with damper fluid in such a way that a highly sensitive response of the shock absorber 100 is guaranteed and so-called stick-slip effects are avoided.

FIG. 5 shows a shock absorber 200 according to a third embodiment of the invention in a lateral view. The shock absorber 200 is of a fundamentally identical construction and operates in principle as the shock absorber 100 of FIGS. 3 and 4. Only the points of differentiation between the shock absorber 200 of FIGS. 5 and 6 in comparison to the shock absorber 100 of FIGS. 3 and 4 will therefore be explained hereinafter. Components of the shock absorber 200 that are identical to, and/or have the same function as, components of the shock absorber 100 are denoted with the same reference signs.

The shock absorber 200 has an upper end 114 which can be connected to a vehicle structure or a wheel suspension. The upper end 114 is formed by means of a pivot pin which extends somewhat into a plunger piston 218, as can also be seen in FIG. 6. The pivot pin is provided with a ball joint which is disposed within the plunger piston 218. As opposed to the plunger piston 118 of the shock absorber 100, the plunger piston 218 does not have a constant diameter across its entire length. The diameter of the plunger piston 218 is enlarged in the region of its right end in FIG. 5 and FIG. 6, and in the region of this enlarged diameter rests on the internal circumference of an outer tube 124. It can therefore be seen by means of a comparison of FIGS. 3 and 4, on the one hand, and FIGS. 5 and 6, on the other hand, that the plunger piston 218 has to be inserted into the outer tube from the right end in FIGS. 5 and 6. The diameter of the plunger piston 218 is enlarged in comparison to the diameter of the latter at the upper end 114 of the shock absorber 200.

The plunger piston 218 extends into the outer tube 124. A friction bearing 154 for supporting transverse forces that are transmitted from the plunger piston 218 to the outer tube 124 is provided in the region of the end of the plunger piston 218 that is located in the outer tube 124, wherein the plunger piston 218 has the enlarged diameter at this end. It can be established herein that only the friction bearing 154 but no seal is consciously provided at this end of the plunger piston 218 that is located within the outer tube 124. This is because the plunger piston displaces fluid within the outer tube by way of the volume of said plunger piston, specifically by way of the volume of said plunger piston that is disposed in the piston chamber of the outer tube 124. It can be seen in the sectional view of FIG. 6 that the plunger piston 218, directly behind the end of the plunger piston 218 that is located in the outer tube 124, has a plurality of passages 208 which lead into an annular intermediate space 210 between the inner wall of the outer tube 124 and the outer wall of the plunger piston 218. Consequently, no seal is required at the location of the friction bearing 124 in the first place.

At the lower end of the shock absorber 200, the outer tube 124 is received in a valve block 128 on which the compensation vessel 130 and a traction phase valve 134 and a compression phase valve 132 are also disposed. The valve block 128, the compensation vessel 130, the traction phase valve 134 and the compression phase valve 132 are designed identically to the shock absorber 100 of FIGS. 3 and 4, and will therefore not be explained again.

When the shock absorber 100, proceeding from the state illustrated in FIGS. 5 and 6, reduces its length, the plunger piston 218 consequently has to plunge farther into the outer tube 124. As a result, oil from a first piston chamber 136 is displaced in the direction toward a first fluid duct 138 in the valve block 128, and makes its way to the compression phase valve 132. As has been explained, the functional mode of the shock absorber 200 is fundamentally identical to the functional mode of the shock absorber 100 of FIGS. 3 and 4. In the case of the shock absorber 200, the plunger piston 218 is only embodied with an end which is enlarged in terms of the diameter and is located in the outer tube 124, so that—as opposed to the shock absorber 100—the annular space 210 between the external circumference of the plunger piston 218 and the internal circumference of the outer tube 124 is also formed.

When, proceeding from the position in FIG. 5 and FIG. 6, the length of the shock absorber 200 is enlarged, the plunger piston 218 is moved somewhat out of the outer tube 124. A piston 142 which is provided with a radial seal 204 is disposed within the hollow plunger piston 218. The piston 142, in addition to the internal circumference of the plunger piston 218, is supported by means of a friction bearing 202. The piston 142 is disposed so as to be immovable relative to the outer tube 124 because said piston 142 is connected to the valve block 128, and thus to the lower right end of the outer tube 124 in FIG. 5 and FIG. 6, by means of a hollow piston rod 150. In the embodiment illustrated, the piston rod 150 is fastened to the valve block 128. When the plunger piston 218 is thus extracted somewhat from the outer tube 124, oil from a second piston chamber 144 is displaced into the hollow piston rod 150 and in the direction toward a second fluid duct 146 in the valve block 128. The oil then flows via the traction phase valve 134.

The plunger piston 218 is guided on the left end of the outer tube 124 in FIG. 6 by means of a first radial bearing 152, which is embodied as a friction bearing for supporting the transverse forces. A seal 156 and a wiper 256 are also disposed after the radial bearing 152, toward the left end of the outer tube 124 in FIG. 5 and FIG. 6. In this way, no oil, or no significant quantities of oil, from the annular space 210 can escape through the left end of the outer tube 124 in FIG. 5 and FIG. 6.

As in the shock absorber 100 of FIGS. 3 and 4, the radial bearings 152, 154 and 202 are at all times lubricated with oil, or damper fluid, so that a sensitive response of the shock absorber 200 is guaranteed and so-called stick-slip effects are avoided.

The external diameter of the plunger piston 218 is indicated by the letter A in FIG. 6. The internal diameter of the plunger piston 218 is indicated by the letter B. The external diameter of the piston 142 is consequently the same size as, or only insignificantly smaller than, the diameter B. The external diameter of the piston rod 150 is indicated by the letter C. The piston rod 150 is disposed so as to be displaceable in the plunger piston 218, and a seal 206 in the region of the passage of the piston rod 150 through an end region of the plunger piston 218 on the right in FIG. 6 prevents oil from making its way from the damper chamber 144 directly into the damper chamber 136. As has been explained, oil from the damper chamber 144 is however displaced into the interior of the hollow piston rod 150. The diameter A is smaller than the diameter D. The diameter C is smaller than the diameter B. The diameter B is smaller than the diameter A.

As opposed to the shock absorber 10 of FIGS. 1 and 2, larger damper travels can be achieved with the shock absorbers 100, 200 of FIGS. 3, 4, 5 and 6, or the shock absorbers 100, 200 can be of a shorter design than the shock absorber 10 at the same damper travel.

Using the shock absorbers 10, 100, 200, it is possible to embody wheel suspensions of vehicles, in which the shock absorber is designed to absorb wheel steering forces, in a very stable and at the same time lightweight manner. As a result, the shock absorbers 10, 100, 200 according to the invention are particularly suitable for telescopic suspension forks for two-wheelers, for example motorcycles or mountain bikes or electric bikes, as well as for MacPherson strut suspensions of motor vehicles, in particular racing vehicles.

1. A shock absorber for a wheel suspension of a vehicle, wherein the shock absorber is designed to absorb wheel steering forces, the shock absorber comprising an outer tube having a plunger piston displaceable in the outer tube in and counter to a longitudinal direction of the outer tube for damping a movement when altering a length of the shock absorber in a first direction, and comprising a piston including a radial seal, the piston being for damping a movement when altering the length of the shock absorber in a second direction counter to the first direction.

2. The shock absorber as claimed in claim 1, further comprising a seal disposed in a region of an open end of the outer tube, wherein the plunger piston comprises a piston in portions resting directly on an inside of the outer tube, wherein the plunger piston is movably received in the open end and is sealed in relation to an inner wall of the outer tube by the seal, and wherein the plunger piston plunges into a piston chamber formed by the outer tube and via its volume disposed in the piston chamber displaces damper fluid in the piston chamber.

3. The shock absorber as claimed in claim 1, wherein the plunger piston is configured to be hollow at least in portions, the shock absorber further comprising a fastening device for fastening the shock absorber to a vehicle structure or to a wheel suspension, and the fastening device is at least in portions disposed within the plunger piston.

4. The shock absorber as claimed in claim 3, wherein the fastening device comprises a ball joint.

5. The shock absorber as claimed in claim 4, wherein the ball joint is disposed completely within the plunger piston.

6. The shock absorber as claimed in claim 1,
wherein the plunger piston is configured to be hollow at least in portions, the plunger piston at a first bearing point in a region of an open end of the outer tube is mounted radially on an internal circumference of the outer tube, and the plunger piston at a second bearing point is mounted radially on the internal circumference of the outer tube, a wall thickness of the plunger piston in a region which comes into contact with the first bearing point when altering the length of the shock absorber is smaller than a wall thickness of the plunger piston in a region which comes into contact with the second bearing point when altering the length of the shock absorber.

7. The shock absorber as claimed in claim 1, wherein the plunger piston is configured to be hollow at least in portions, and the piston is provided with a radial seal and is disposed for displacement within a cavity of the plunger piston.

8. The shock absorber as claimed in claim 1, wherein the piston is provided with a radial seal and is connected to the plunger piston by a piston rod.

9. The shock absorber as claimed in claim 1,
wherein the plunger piston displaces damper fluid in a direction toward a fluid duct lying outside the outer tube, the fluid duct being provided with a damper valve.

10. The shock absorber as claimed in claim 1,
wherein the piston provided with a radial seal displaces damper fluid in a direction toward a fluid duct disposed outside the outer tube, the fluid duct being provided with a damper valve.

11. A telescopic suspension fork for a two-wheeler, having at least one shock absorber as claimed in claim 1.

12. A MacPherson strut suspension for a motor vehicle, having at least one shock absorber as claimed in claim 1.
